(19) United States
(12) Patent Application Publication
(10) Pub. No.: US 2023/0139270 A1
(43) Pub. Date: May 4, 2023

(54) ECO-FRIENDLY MARINE-FARM TYPE ANCHOR MODULE AND FLOATING PHOTOVOLTAIC INSTALLATION STRUCTRUE USING THEREOF, FLOATING WIND POWER SYSTEM INSTALLATION STRUCTURE USING THEREOF, AND FLOATING BREAKWATER INSTALLATION STRUCTRUE USING THEREOF

(71) Applicant: SEMI CO., LTD., Jeonju-si (KR)

(72) Inventors: Hyo LEE, Jeonju-si (KR); Noh Joon PARK, Jeonju-si (KR); Ki Nam CHOI, Gunsan-si (KR)

(73) Assignee: SEMI CO., LTD., Jeonju-si (KR)

(21) Appl. No.: 17/534,437

(22) Filed: Nov. 23, 2021

(30) Foreign Application Priority Data
Nov. 3, 2021 (KR) 10-2021-0150043

(51) Int. Cl. B63B 35/44; H02S 10/40; H02S 20/30; A01K 61/65

(52) U.S. Cl. CPC B63B 35/44; A01K 61/65; H02S 10/40; H02S 20/30; B63B 2035/4453

(57) ABSTRACT

Disclosed herein is an overwater photovoltaic panel installation structure having an environment-friendly marine-farm-type mooring anchor module that supports a photovoltaic panel on the water and includes a growth space where aquatic organisms are growable. The environment-friendly marine-farm-type mooring anchor module including a growth space where aquatic organisms are growable, includes an anchor module body defining an external appearance thereof, a frame section disposed inside the anchor module body and made of a more rigid material than the anchor module body, and a connection section exposed through an upper surface of the anchor module body and having both lower ends coupled to the frame section. The anchor module body has a plurality of growth space sections recessed from at least one surface thereof to provide a growth space for aquatic organisms.

### TECHNICAL FIELD

The present disclosure relates to an environment-friendly marine-farm-type mooring anchor module, and an overwater photovoltaic panel installation structure, floating wind power system installation structure, and floating breakwater installation structure including the same, and more particularly, to an environment-friendly marine-farm-type mooring anchor module that supports a photovoltaic panel or a wind power system on the water and includes a growth space where aquatic organisms are growable, and an overwater photovoltaic panel installation structure, floating wind power system installation structure, and floating breakwater installation structure including the same.

### BACKGROUND ART

With the trend of stricter international regulations on environmental pollution and greenhouse gas in recent years, renewable energy systems such as photovoltaic systems are being actively studied in order to replace the use of fossil fuels such as coal. The photovoltaic system is a power generation system that uses solar heat to produce electricity, and may be classified into a terrestrial photovoltaic system and an overwater photovoltaic system according to the installation environment thereof. The overwater photovoltaic system is a system in which photovoltaic panels are installed to float on the water such as seawalls, seas, streams, rivers, dams, reservoirs, and freshwater lakes. The overwater photovoltaic system is in the spotlight because it can overcome the space constraints on the ground and have photovoltaic facilities installed in a large space without damaging agricultural land or forests.

In addition, the overwater photovoltaic system is also advantageous in that it can have enhanced power generation efficiency by virtue of cooling effects above the surface of water, reduce direct sunlight on the surface of water to prevent green algae and red algae, and increase the number of fish living therebelow.

### Patent Document

Korean Pat. No. 10-2085864 (Mar. 2, 2020)

### DISCLOSURE

### Technical Problem

The present disclosure is directed to an environment-friendly marine-farm-type mooring anchor module that can provide an ecologically friendly environment, and an overwater photovoltaic panel installation structure, floating wind power system installation structure, and floating breakwater installation structure including the same.

### Technical Solution

In accordance with one aspect of the present disclosure, there is provided an environment-friendly marine-farm-type mooring anchor module including a growth space where aquatic organisms are growable, which includes an anchor module body defining an external appearance thereof, a frame section disposed inside the anchor module body and made of a more rigid material than the anchor module body, and a connection section exposed through an upper surface of the anchor module body and having both lower ends coupled to the frame section. The anchor module body has a plurality of growth space sections recessed from at least one surface thereof to provide a growth space for aquatic organisms. Each of the growth space sections includes an inlet area disposed on an associated surface of the anchor module body, a bottom area facing the inlet area and forming a bottom surface of the growth space section, and a side area connecting the inlet area to the bottom area. The inlet area is larger in size than the bottom area, and the side area is inclined. Each of the growth space sections has a pattern part formed on a surface thereof, the pattern part including a plurality of pattern members protruding or recessed with respect to the surface of the growth space section.

In accordance with another aspect of the present disclosure, there is provided an environment-friendly marine-farm-type mooring anchor module including a growth space where aquatic organisms are growable, which includes an anchor module body defining an external appearance thereof, a frame section disposed inside the anchor module body and made of a more rigid material than the anchor module body, and a connection section exposed through an upper surface of the anchor module body and having both lower ends coupled to the frame section. The anchor module body has a plurality of growth space sections recessed from at least one surface thereof to provide a growth space for aquatic organisms. The growth space sections are in communication with each other. Each of the growth space sections includes an inlet area disposed on an associated surface of the anchor module body and a communication area connected to the inlet area. The inlet areas of the growth space sections, which are defined respectively in parallel on one of the sides of the anchor module body and the other side facing the same, are in direct communication with each other through the associated communication areas of the growth space sections. The inlet areas of the growth space sections, which are defined respectively on one of the sides of the anchor module body and the other side adjacent and perpendicular to the same, are in communication with each other through the associated communication areas of the growth space sections orthogonal to each other. The frame section is disposed in a portion of the anchor module body in which the communication areas are not defined, so as not to be exposed through the communication areas. Each of the communication areas has a cross-sectional size smaller than or equal to an associated one of the inlet areas. The cross-sectional size of the communication area is decreased as the distance from the inlet area is increased. Each of the growth space sections has a pattern part formed on a surface thereof, the pattern part including a plurality of pattern members protruding or recessed with respect to the surface of the growth space section.

In accordance with still another aspect of the present disclosure, there is provided an environment-friendly marine-farm-type mooring anchor module including a growth space where aquatic organisms are growable, which includes an anchor module body defining an external appearance thereof, a frame section disposed inside the anchor module body and made of a more rigid material than the anchor module body, and a connection section exposed through an upper surface of the anchor module body and having both lower ends coupled to the frame section. The anchor module body has a plurality of growth space sections recessed from at least one surface thereof to provide a growth space for aquatic organisms. The growth space sections have different shapes and sizes. One of the growth space sections and another growth space section adjacent thereto have different shapes or sizes. The growth space sections have at least two of rectangular, pentagonal, triangular, and circular shapes. Each of the growth space sections has a pattern part formed on a surface thereof, the pattern part including a plurality of pattern members protruding or recessed with respect to the surface of the growth space section.

The anchor module body may have a body-side pattern part formed in a remaining area thereof where the growth space sections are not defined, the body-side pattern part including a plurality of body-side pattern members protruding or recessed with respect to the anchor module body.

Each of the pattern members may have one or a combination of two or more of circular, rectangular, and linear shapes. The pattern members formed in each of the growth space sections may have different sizes or densities from the body-side pattern members.

The anchor module body of the mooring anchor module may be made of stone or concrete. Each of the growth space sections of the anchor module body may have more pores than in other portions of the anchor module body in which the growth space sections are not defined. The anchor module body may have at least one of a ceramic coating layer, an ocher coating layer, and a nanosilver coating layer formed on the surface thereof.

The frame section may be made of at least one or a combination of two or more of steel, fiber reinforced polymer (FRP) reinforcing material, glass fiber reinforced polymer (GFRP) reinforcing material, and carbon fiber reinforced polymer (CFRP) reinforcing material.

The distance between the inlet area and the bottom area may be 1/20 to ⅓ of the distance between one of the sides of the anchor module body and the other side facing the same.

In accordance with yet another aspect of the present disclosure, there is provided an overwater photovoltaic panel installation structure, including the environment-friendly marine-farm-type mooring anchor module according to the above aspects, which further includes buoyancy bodies spaced apart from each other, a photovoltaic panel support assembly supported on the buoyancy bodies, a plurality of photovoltaic panels supported by the photovoltaic panel support assembly, and a connection unit having one side connected to the photovoltaic panel support assembly and the other side fixed to the environment-friendly marine-farm-type mooring anchor module. The environment-friendly marine-farm-type mooring anchor module is connected to the photovoltaic panel support assembly, is configured to moor the photovoltaic panel support assembly on the water, and is seated on the floor surface of the ocean.

The growth space sections may not overlap the frame section of the mooring anchor module. The connection section may include a connection area rounded and exposed upward from the anchor module body and having both ends embedded within the anchor module body, and bent areas disposed at and bent in a direction orthogonal to both ends of the connection area. The connection section may be fixed to the anchor module body in a state in which the bent areas of the connection section are latched to at least one frame of the frame section and another frame in parallel therewith.

The overwater photovoltaic panel installation structure may further include an air supply unit disposed on the photovoltaic panel support assembly and operated by power supplied from the photovoltaic panels. Each of the growth space sections may have a plurality of air supply holes formed therein. The anchor module body may have at least air flow hole to which the air supply holes are connected. The connection unit may include a first conduit formed therein. One end of the first conduit may be connected to the air supply unit and the other end of the first conduit may communicate with the air flow hole, thereby allowing air to be supplied from the air supply unit to the air flow hole.

The overwater photovoltaic panel installation structure may further include a camera unit installed in the anchor module body to capture an underwater environment, a sensing unit configured to measure an amount of oxygen in the water, a communication unit configured to transmit information about the amount of oxygen in the water measured by the sensing unit to a management device, and a control unit configured to control the air supply unit, the sensing unit, and the communication unit. The connection unit may include a second conduit disposed in parallel with and independent of the first conduit. A probe unit connected to the sensing unit may be inserted at one side thereof into and moved in the second conduit. When the probe unit is moved toward the mooring anchor module in a state in which the probe unit is inserted into the second conduit, the sensing unit may measure the amount of oxygen in the water near the floor surface of the ocean where the mooring anchor module is disposed, so as to transmit information about the measured amount of oxygen in the water to the management device. The control unit may control the air supply unit to supply air to the mooring anchor module, based on the information about the amount of oxygen in the water, when the measured amount of oxygen in the water is smaller than a predetermined reference amount of oxygen. The reference amount of oxygen may vary with the season.

The overwater photovoltaic panel installation structure may further include a power cable for transmitting electric power generated by the photovoltaic panels, and at least a portion of the power cable may be covered by the mooring anchor module.

In accordance with still yet another aspect of the present disclosure, there is provided a floating wind power system installation structure, including the environment-friendly marine-farm-type mooring anchor module according to the above aspects, which further includes a wind power system including a pillar, a turbine unit located at the top of the pillar, and at least two blade units rotatably disposed on the turbine unit, a wind power system support assembly disposed at the bottom of the pillar of the wind power system, and a connection unit having one side connected to the wind power system support assembly and the other side fixed to the environment-friendly marine-farm-type mooring anchor module. The environment-friendly marine-farm-type mooring anchor module is connected to the wind power system support assembly, allows the wind power system support assembly to be moored such that the turbine unit of the wind power system supported by the wind power system support assembly is exposed to the outside, and is seated on the floor surface of the ocean.

In accordance with a further aspect of the present disclosure, there is provided a floating breakwater installation structure, including the environment-friendly marine-farm-type mooring anchor module according to the above aspects, which further includes a breakwater module including a buoyancy body formed therein and a cover member surrounding the buoyancy body on the outside, at least 50% of the volume of the breakwater module being exposed to the surface of water, and a connection unit having one side connected to the breakwater module and the other side fixed to the environment-friendly marine-farm-type mooring anchor module, The environment-friendly marine-farm-type mooring anchor module is connected to the breakwater module through the connection unit and is seated on the floor surface of the ocean.

### Advantageous Effects

According to the present disclosure, it is possible to provide an ecologically friendly environment by providing a space in which aquatic organisms can grow smoothly in the body of water where an overwater photovoltaic panel installation structure, a floating wind power system installation structure, and a floating breakwater installation structure are installed, and simultaneously by allowing the overwater photovoltaic panel installation structure, the floating wind power system installation structure, and the floating breakwater installation structure to be stably moored.

### DESCRIPTION OF DRAWINGS

FIG. 1 is a view illustrating an overwater photovoltaic panel installation structure according to an embodiment of the present disclosure.

FIG. 2 is a view illustrating an environment-friendly marine-farm-type mooring anchor module of the overwater photovoltaic panel installation structure of FIG. 1.

FIG. 3 is a view illustrating an internal configuration of the environment-friendly marine-farm-type mooring anchor module of FIG. 2.

FIG. 4 is a view illustrating a mooring anchor module of an overwater photovoltaic panel installation structure according to another embodiment of the present disclosure.

FIG. 5 is a view illustrating a mooring anchor module of an overwater photovoltaic panel installation structure according to still another embodiment of the present disclosure.

FIG. 6 is a view illustrating a mooring anchor module of an overwater photovoltaic panel installation structure according to yet another embodiment of the present disclosure.

FIG. 7 is a view illustrating a mooring anchor module of an overwater photovoltaic panel installation structure according to still yet another embodiment of the present disclosure.

FIG. 8 is a cross-sectional view of the mooring anchor module taken along line VIII-VIII of FIG. 7.

FIG. 9 is a view illustrating a configuration of an overwater photovoltaic panel installation structure according to a further embodiment of the present disclosure.

FIG. 10 is a view illustrating a configuration of an environment-friendly marine-farm-type mooring anchor module according to another further embodiment of the present disclosure.

FIG. 11 is a view illustrating a configuration of an environment-friendly marine-farm-type mooring anchor module according to still another further embodiment of the present disclosure.

FIG. 12 is a view illustrating a floating wind power system installation structure according to yet another further embodiment of the present disclosure.

FIG. 13 is a view illustrating a configuration of an environment-friendly marine-farm-type mooring anchor module according to still yet another further embodiment of the present disclosure.

FIG. 14 is a view illustrating a floating breakwater installation structure according to a still further embodiment of the present disclosure.

### BEST MODE

Advantages and features of the present disclosure and methods of achieving them will become apparent with reference to the embodiments described below in detail in conjunction with the accompanying drawings. The present disclosure may, however, be embodied in different forms, and should not be construed as being limited to the embodiments set forth herein. Rather, these embodiments are provided so that the disclosure will be thorough and complete, and will fully convey the scope of the present disclosure to those skilled in the art. The present disclosure should be defined based on the entire content set forth in the appended claims.

Although the terms such as “first” and/or “second” are used to describe various components, these components are not limited by these terms, of course. These terms are used merely to distinguish the corresponding component from other component(s). Therefore, it is natural that the first component set forth herein may be a second component within the spirit of the present disclosure.

Throughout the disclosure, like reference numerals refer to like components.

Individual features of various embodiments of the present disclosure may be partially or wholly coupled or combined with each other and may be connected and actuated technically in various manners as will be fully understood by those skilled in the art. The embodiments of the present disclosure may be implemented independently of each other or may be implemented in association with each other.

Meanwhile, the potential effects that can be expected by the technical features of the present disclosure although not specifically mentioned herein are treated as being described in the specification. The embodiments of the present disclosure are provided to more completely describe the disclosure to those of ordinary skill in the art, and the details shown in the drawings may be exaggerated compared to the actual implementation of the present disclosure. In certain embodiments, detailed descriptions of configurations well known by those skilled in the art will be omitted to avoid obscuring appreciation of the disclosure.

Hereinafter, exemplary embodiments of the present disclosure will be described in detail with reference to the accompanying drawings.

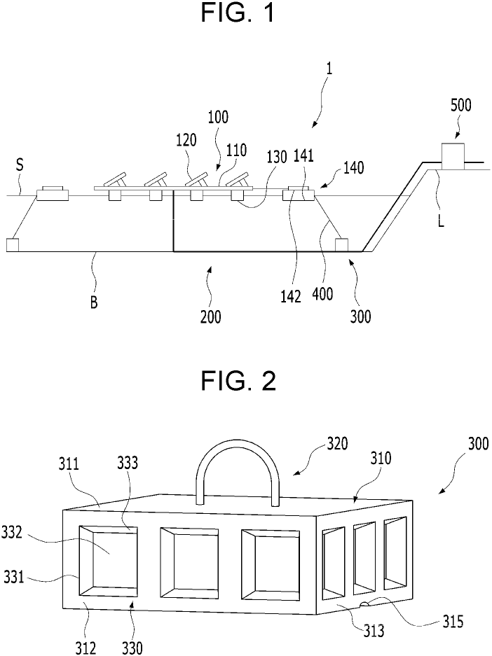

FIG. 1 is a view illustrating an overwater photovoltaic panel installation structure according to an embodiment of the present disclosure.

Referring to FIG. 1, the overwater photovoltaic panel installation structure, which is designated by reference numeral 1, according to the embodiment of the present disclosure is installed in the ocean or freshwater lake, is moored while floating on the surface of water by buoyancy, and provides a growth space where aquatic organisms can grow.

In more detail, the overwater photovoltaic panel installation structure 1 includes buoyancy bodies 130 spaced apart from each other, a photovoltaic panel support assembly 110 supported on the buoyancy bodies 130, a plurality of photovoltaic panels 120 supported by the photovoltaic panel support assembly 110, an environment-friendly marine-farm-type mooring anchor module connected to the photovoltaic panel support assembly 110, configured to moor the photovoltaic panel support assembly 110 on the water S, and seated on the floor surface of the ocean, a connection unit 400 having one side connected to the photovoltaic panel support assembly 110 and the other side fixed to the environment-friendly marine-farm-type mooring anchor module, and a power cable 200 for transmitting electric power generated by the photovoltaic panels to a management device 500 on the ground L.

Each of the photovoltaic panels 120 is a power generation unit that generates electric power based on incident sunlight, and may be formed of, for example, a polysilicon solar panel or a CIGS solar panel.

The photovoltaic panel support assembly 110 provides an installation place where the photovoltaic panel 120 is installed. The photovoltaic panel support assembly 110 may include a photovoltaic panel support frame (not shown) that allows the photovoltaic panel 120 to be installed while being oriented at a predetermined angle and a main frame (not shown) in which the photovoltaic panel support frame is installed and including a work plate or the like. The photovoltaic panel support assembly 110 may be made of, for example, a lightweight material having corrosion resistance, such as metal or fiber reinforced plastic (FRP). In addition, the main frame of the photovoltaic panel support assembly 110 includes a plurality of support members pivotably connected to each other so as to stably support the photovoltaic panel 120 against an external force generated by storms.

Each of the buoyancy bodies 130 is made of, for example, fiber reinforced plastic (FRP), and is filled therein with air or a lightweight polymer material such as Styrofoam to be floatable on the water S. The photovoltaic panel support assembly 110 is disposed on the plurality of buoyancy bodies 130.

The environment-friendly marine-farm-type mooring anchor module is made of a heavy material such as stone or reinforcing steel, and is seated or fixed on the floor surface of the ocean such as the seabed. In the state in which the environment-friendly marine-farm-type mooring anchor module made of heavy material is seated or fixed on the floor surface of the ocean B so as to be immobile, the photovoltaic panel support assembly 110 connected to the environment-friendly marine-farm-type mooring anchor module by the connection unit 400 may remain moored at a specific position.

In the present embodiment, the environment-friendly marine-farm-type mooring anchor module may consist of a plurality of environment-friendly marine-farm-type mooring anchor modules. The weight and number of environment-friendly marine-farm-type mooring anchor modules may be determined according to the size of the photovoltaic panel support assembly 110 or the like.

In the present embodiment, the photovoltaic panel support assembly 110 further includes a floating connection member 140 formed separately from the main frame.

The floating connection member 140 is directly connected to the environment-friendly marine-farm-type mooring anchor module by the connection unit 400. The floating connection member 140 includes a floating connection member body 141 formed to be floatable on the water S and a connection bracket 142 formed on one side of the floating connection member body 141 and connected to the main frame by an auxiliary connection unit.

In the present embodiment, the connection unit 400 and the auxiliary connection unit may each be made of, for example, a metal material, a fiber material, a rubber material, or the like.

The overwater photovoltaic panel installation structure 1 according to the present embodiment can be suppressed from being damaged by an external force such as storms as the main frame of the photovoltaic panel support assembly 110 is connected to the environment-friendly marine-farm-type mooring anchor module through the floating connection member 140 capable of relative motion.

The management device 500 is connected to the power cable 200 for transmitting electric power to supply the received electric power to a power distribution network, and so on. The management device 500 may include a battery unit (not shown) configured to temporarily store electric power therein. In addition, the management device 500 may receive the operating state information of the photovoltaic panel 120 from the power cable 200 and transmit the power generation status of the photovoltaic panel 120 to the outside.

The power cable 200 is connected at one side thereof to the photovoltaic panel 120, in which state the power cable 200 is connected at one end thereof to the management device 500 while being disposed along the floor surface of the ocean B. In this case, the power cable 200 is disposed such that a portion thereof is covered by the environment-friendly marine-farm-type mooring anchor module. That is, a portion of the power cable 200 is fixed to the floor surface of the ocean B due to the load of the environment-friendly marine-farm-type mooring anchor module, thereby enabling the power cable 200 to be suppressed from moving due to ocean currents or the like. The environment-friendly marine-farm-type mooring anchor module may have a cable fixing groove 315 formed to stably fix the power cable 200.

The environment-friendly marine-farm-type mooring anchor module according to the present embodiment provides a growth space in which aquatic organisms can grow in an aquatic ecosystem, while simultaneously allowing the photovoltaic panel installation structure 1 to be stably moored at a predetermined position by the load thereof.

Hereinafter, the configuration of the environment-friendly marine-farm-type mooring anchor module of the overwater photovoltaic panel installation structure 1 according to the present embodiment will be described in more detail.

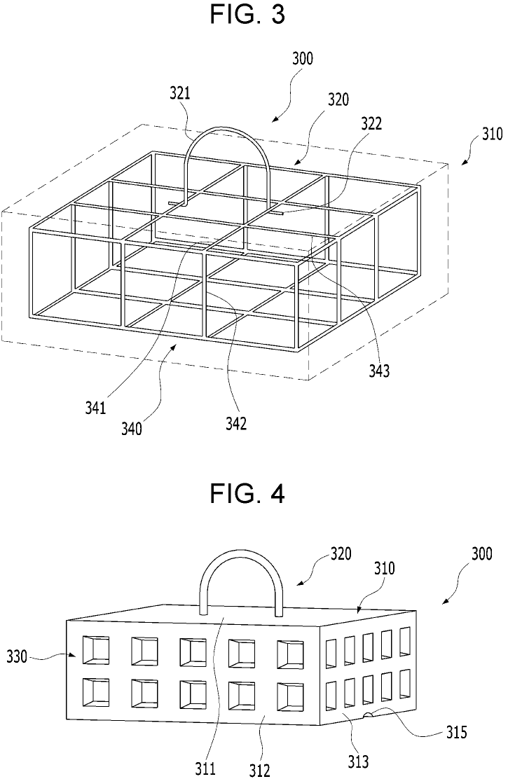

FIG. 2 is a view illustrating an environment-friendly marine-farm-type mooring anchor module of the overwater photovoltaic panel installation structure of FIG. 1. FIG. 3 is a view illustrating the internal configuration of the mooring anchor module of FIG. 2.

Referring to FIGS. 2 and 3, the environment-friendly marine-farm-type mooring anchor module according to the present embodiment includes an anchor module body 310 defining an external appearance thereof, a frame section 340 disposed inside the anchor module body 310 and made of a more rigid material than the anchor module body 310, and a connection section 320 exposed through an upper surface 311 of the anchor module body 310 and having both lower ends coupled to the frame section 340. The anchor module body 310 has a plurality of growth space sections 330 recessed from at least one surface 312 or 313 thereof to provide a growth space for aquatic organisms. The connection section 320 may be a single connection section or consist of a plurality of connection sections.

The anchor module body 310 is, for example, in the form of a rectangular parallelepiped or a cube, and is made of stone such as concrete, which is a heavy material.

The growth space sections 330 may be defined on surfaces forming the sides of the anchor module body 310. Each of the growth space sections 330 includes an inlet area 331 disposed on the associated surface 312 or 313 of the anchor module body 310, a bottom area 332 facing the inlet area 331 and forming a bottom surface of the growth space section 310, and a side area 333 connecting the inlet area 331 to the bottom area 332.

The inlet area 331 of the growth space section 330 may have, for example, a rectangular shape. Each of the growth space sections 330 has more pores than in other portions of the anchor module body 310 where the growth space sections 330 are not defined. Accordingly, it is possible to provide a space in which aquatic organisms, including aquatic plants such as laver and sea mustard and aquatic animals such as shellfish, whelks, and barnacles, can settle and grow more smoothly.

In the growth space section 330, the inlet area 331 is larger in size than the bottom area 332, and the side area 333 is inclined toward the inlet area 331 from the bottom area 332.

The distance between the inlet area 331 and the bottom area 332, that is, the recessed depth of the growth space section 330 is 1/20 to ⅓ of the distance between one of the sides of the anchor module body 310 and the other side facing the same.

In the present embodiment, the growth space sections 330 may be configured such that three growth space sections are arranged in one row in the longitudinal direction on each surface 312 or 313 of the anchor module body 310.

Each of the growth space sections 330 is formed so as not to overlap the frame section 340 of the environment-friendly marine-farm-type mooring anchor module, thereby suppressing exposure of the frame section 340 to the outside.

The frame section 340 may be disposed inside the anchor module body 310 to maintain the rigidity of the environment-friendly marine-farm-type mooring anchor module. The frame section 340 may be made of, for example, at least one or a combination of two or more of metal, fiber reinforced polymer (FRP) reinforcing material, glass fiber reinforced polymer (GFRP) reinforcing material, and carbon fiber reinforced polymer (CFRP) reinforcing material.

The frame section 340 includes a plurality of first frames 341 extending in a horizontal direction, a plurality of second frames 342 orthogonal to the first frames 341 in the horizontal direction, and a plurality of third frames 343 bent vertically from the first and second frames 341 and 342.

The connection section 320 includes a connection area 321 rounded and exposed upward from the anchor module body 321 and having both ends embedded within the anchor module body 310, and a pair of bent areas 322 disposed at and bent in a direction orthogonal to both ends of the connection area 321. The connection unit 400 is connected to the connection area 321 of the connection section 320, and the connection section 320 may be a single connection section or consist of a plurality of connection sections.

The pair of bent areas 322 of the connection section 320 are latched to one of the first frames 341 of the frame section 340 and another first frame 341 in parallel therewith. The connection section 320 is fixed to the anchor module body 310 with the bent areas 322 latched to the associated respective first frames 341. Accordingly, when tension is applied to the connection section 320, the bent areas 322 of the connection section 320 receives a force applied in a direction opposite thereto by the frame section 340, thereby enabling the overwater photovoltaic panel installation structure to be more stably moored.

According to the proposed embodiment, it is possible to provide a more ecologically friendly environment by providing a space in which aquatic organisms can grow smoothly in the body of water where the overwater photovoltaic panel installation structure is installed, and simultaneously by allowing the overwater photovoltaic panel installation structure to be stably moored.

FIG. 4 is a view illustrating a mooring anchor module of an overwater photovoltaic panel installation structure according to another embodiment of the present disclosure.

The overwater photovoltaic panel installation structure according to the present embodiment has substantially the same configuration as that illustrated in FIGS. 1 to 3, except that there is a difference in the configuration of the mooring anchor module. Therefore, the main features of the present embodiment will be described below.

Referring to FIG. 4, the environment-friendly marine-farm-type mooring anchor module according to the present embodiment includes a plurality of growth space sections 330 arranged in two rows on at least one surface 312 or 333.

Each of the growth space sections 330 according to the present embodiment may be smaller in size than the growth space section 330 of the environment-friendly marine-farm-type mooring anchor module illustrated in FIGS. 1 to 3.

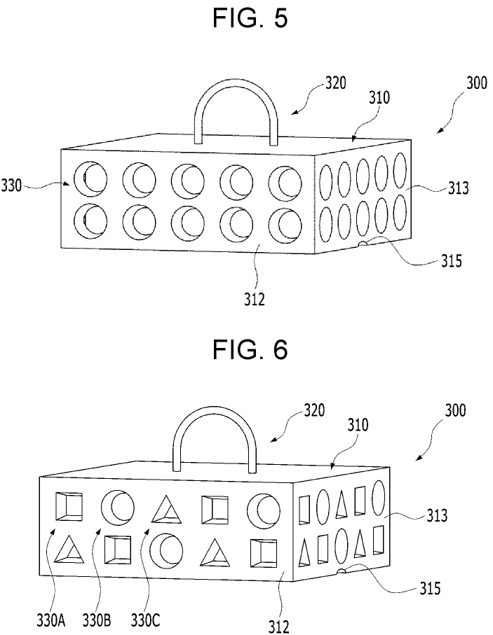

FIG. 5 is a view illustrating a mooring anchor module of an overwater photovoltaic panel installation structure according to still yet another embodiment of the present disclosure.

The overwater photovoltaic panel installation structure according to the present embodiment has substantially the same configuration as that illustrated in FIGS. 1 to 3, except that there is a difference in the configuration of the mooring anchor module. Therefore, the main features of the present embodiment will be described below.

Referring to FIG. 5, the mooring anchor module according to the present embodiment includes a plurality of growth space sections 330 each having a circular shape. In this case, each of the growth space sections 330 may include an inlet area and a bottom area, which have different sizes.

FIG. 6 is a view illustrating a mooring anchor module of an overwater photovoltaic panel installation structure according to still yet another embodiment of the present disclosure.

The overwater photovoltaic panel installation structure according to the present embodiment has substantially the same configuration as that illustrated in FIGS. 1 to 3, except that there is a difference in the configuration of the mooring anchor module. Therefore, the main features of the present embodiment will be described below.

Referring to FIG. 6, the environment-friendly marine-farm-type mooring anchor module according to the present embodiment includes a plurality of growth space sections 330 having different shapes and sizes.

In more detail, one of the growth space sections 330A, 330B, and 330C and another growth space section 330A, 330B, or 330C adjacent thereto have different shapes or sizes, and the growth space sections 330A, 330B, and 330C may have at least two of rectangular, pentagonal, triangular, and circular shapes.

In the present embodiment, the first growth space section 330A may have a rectangular shape, the second growth space section 330B may have a circular shape, and the third growth space section 330C may have a triangular shape. Since the adjacent growth space sections 330A, 330B, and 330C have different shapes, it is possible to create a natural aesthetic appearance.

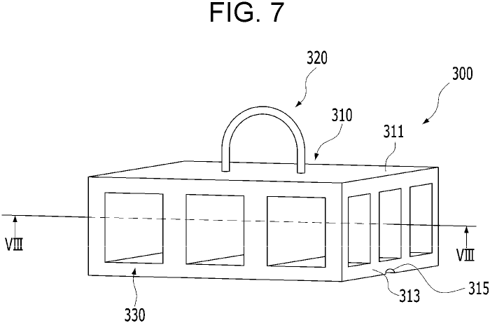

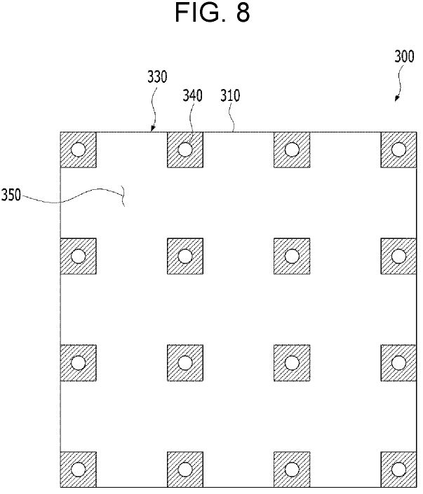

FIG. 7 is a view illustrating a mooring anchor module of an overwater photovoltaic panel installation structure according to still yet another embodiment of the present disclosure. FIG. 8 is a cross-sectional view of the mooring anchor module taken along line VIII-VIII of FIG. 7.

The overwater photovoltaic panel installation structure according to the present embodiment has substantially the same configuration as that illustrated in FIGS. 1 to 3, except that there is a difference in the configuration of the mooring anchor module. Therefore, the main features of the present embodiment will be described below.

Referring to FIGS. 7 and 8, the environment-friendly marine-farm-type mooring anchor module according to the present embodiment includes a plurality of growth space sections 330 communicating with each other.

In more detail, each of the growth space sections 330 includes an inlet area 331 disposed on an associated surface of an anchor module body 310 and a communication area 350 connected to the inlet area 331.

The inlet areas 331 of the growth space sections 330, which are defined respectively in parallel on one of the sides of the anchor module body 310 and the other side facing the same, are in direct communication with each other through the associated communication areas 350. In addition, the inlet areas 331 of the growth space sections 330, which are defined respectively on one 312 of the sides of the anchor module body 310 and the other side 313 adjacent and perpendicular to the same, are in communication with each other through the associated communication areas 350 orthogonal to each other.

Each of the communication areas 350 has a cross-sectional size smaller than or equal to the associated inlet area 331. In addition, the cross-sectional size of the communication area 350 is decreased as the distance from the inlet area 331 is increased. That is, the cross-sectional size of the communication area 350 is gradually decreased in a direction away from the inlet area 331. Since the communication area 350 has different cross-sections in size at a portion adjacent to the inlet area 331 and a portion separated therefrom, it is possible to provide a space in which aquatic organisms can grow more stably.

Meanwhile, a frame section 340 is disposed in a portion of the anchor module body 310 in which the communication areas 350 are not defined, so as not to be exposed through the communication areas 350.

Although the present embodiment describes that all of the growth space sections 330 are in communication with each other, the present disclosure may also include a configuration in which only some of the growth space sections 330 are in communication with each other.

According to the proposed embodiment, since the growth space sections 330 are in communication with each other so that aquatic organisms grow within the environment-friendly marine-farm-type mooring anchor module, it is possible to more stably maintain the growth environment.

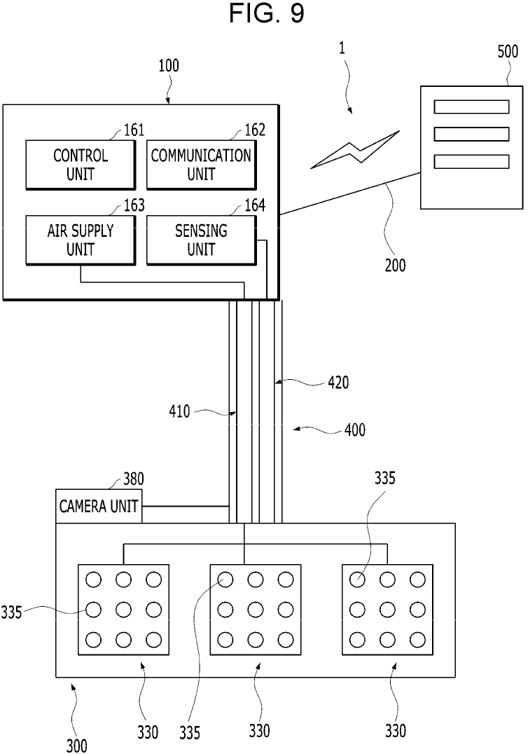

FIG. 9 is a view illustrating a configuration of an overwater photovoltaic panel installation structure according to a further embodiment of the present disclosure.

The overwater photovoltaic panel installation structure according to the present embodiment has substantially the same configuration as that illustrated in FIGS. 1 to 3, except that there is a difference in the configuration for supplying air near the seabed where the mooring anchor module is installed and for sensing underwater conditions. Therefore, the main features of the present embodiment will be described below.

Referring to FIG. 9, the overwater photovoltaic panel installation structure, which is designated by reference numeral 1, according to the present embodiment may monitor an underwater environment near the floor surface of the ocean where the environment-friendly marine-farm-type mooring anchor module is installed, so as to improve underwater environmental factors such as an amount of dissolved oxygen to be suitable for the growth of aquatic organisms.

In more detail, the overwater photovoltaic panel installation structure 1 according to the embodiment of the present disclosure further includes an air supply unit 163 disposed on the photovoltaic panel support assembly 110 and operated by power supplied from the photovoltaic panel 120, a sensing unit 164 configured to measure an amount of oxygen in the water, a communication unit 162 configured to communicate with an external device such as the management device 500 and transmit information about the amount of oxygen in the water measured by the sensing unit 164 to the management device 500, and a control unit 161 configured to control the air supply unit 163, the sensing unit 164, and the communication unit 162.

Each growth space section 330 of the environment-friendly marine-farm-type mooring anchor module has a plurality of air supply holes 335 formed therein, and the anchor module body 310 has at least air flow hole to which the air supply holes 335 are connected.

The connection unit 400 includes a first conduit 410 formed inside the connection unit, and a second conduit 420 disposed in parallel with and independent of the first conduit 410.

One end of the first conduit 410 is connected to the air supply unit 163 and the other end of the first conduit 410 communicates with the air flow hole of the anchor module body 310, thereby enabling air to be supplied from the air supply unit 163 to the air flow hole.

A probe unit (not shown) connected to the sensing unit 164 is inserted at one side thereof into and moved in the second conduit 420. When the probe unit is moved toward the mooring anchor module 300 in the state in which the probe unit is inserted into the second conduit 420, the sensing unit 164 measures the amount of oxygen in the water near the floor surface of the ocean where the mooring anchor module 300 is disposed, so as to transmit information about the measured amount of oxygen to the control unit 161 and the management device 500.

The control unit 161 controls the air supply unit 163 to supply air to the mooring anchor module, based on the information about the amount of oxygen, when the measured amount of oxygen in the water is smaller than a predetermined reference amount of oxygen. In this case, the reference amount of oxygen may vary with the season.

Meanwhile, the overwater photovoltaic panel installation structure 1 further includes a camera unit 380 installed in the mooring anchor module to capture an underwater ecological environment. The camera unit 380 may be, for example, an underwater camera capable of operating in an underwater environment. The camera unit 380 may be electrically connected to the sensing unit 164 or the control unit 161 through the second conduit 420 to transmit the captured image to the outside.

According to the proposed embodiment, it is possible to more stably maintain an aquatic ecosystem by easily measuring the amount of oxygen in the water near the floor surface of the ocean where the environment-friendly marine-farm-type mooring anchor module is installed, and by supplying air to the environment-friendly marine-farm-type mooring anchor module when the amount of oxygen in the water is insufficient.

FIG. 10 is a view illustrating a configuration of an environment-friendly marine-farm-type mooring anchor module according to still yet another further embodiment of the present disclosure.

The environment-friendly marine-farm-type mooring anchor module, which is designated by reference numeral 300, according to the present embodiment has substantially the same configuration as that of the overwater photovoltaic panel installation structure illustrated in FIGS. 1 to 3, except for some configurations. Therefore, the main features of the present embodiment will be described below.

Referring to FIG. 10, the environment-friendly marine-farm-type mooring anchor module 300 according to the present embodiment includes a plurality of growth space sections 330, each having a pattern part 350 formed on the surface thereof. The pattern part 350 includes a plurality of pattern members 351 protruding or recessed with respect to the surface of the growth space section 330.

That is, it is possible to more easily settle aquatic organisms in the growth space section 330 since the pattern members 351 protrude or are recessed with respect to the surface of the growth space section 330. Each of the pattern members 351 may have one or a combination of two or more of circular, rectangular, and linear shapes.

The environment-friendly marine-farm-type mooring anchor module 300 may include an anchor module body 310 having an anti-precipitation layer (not shown) formed on the surface thereof. The anti-precipitation layer may be at least one of a ceramic coating layer, an ocher coating layer, and a nanosilver coating layer. That is, when the environment-friendly marine-farm-type mooring anchor module 300 according to the embodiment of the present disclosure is made of, for example, a concrete material, the anti-precipitation layer may be further applied to the anchor module body 310 in order to suppress the precipitation of organic compounds that may affect the marine environment from the anchor module body 310 in the state in which the environment-friendly marine-farm-type mooring anchor module 300 is disposed in the ocean.

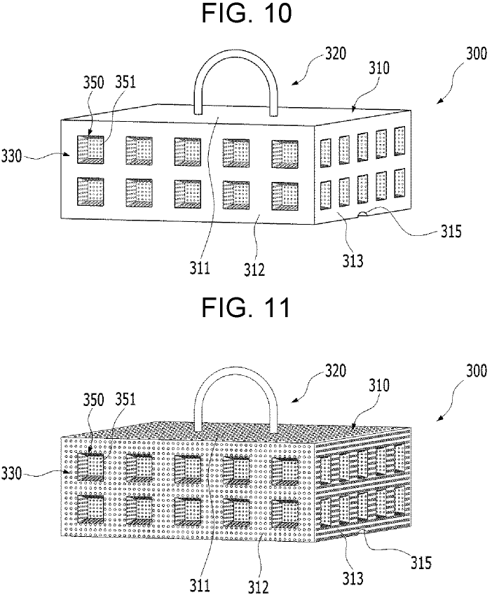

FIG. 11 is a view illustrating a configuration of an environment-friendly marine-farm-type mooring anchor module according to still yet another further embodiment of the present disclosure.

The environment-friendly marine-farm-type mooring anchor module, which is designated by reference numeral 300, according to the present embodiment has substantially the same configuration as that illustrated in FIG. 10, except for some configurations. Therefore, the main features of the present embodiment will be described below.

Referring to FIG. 11, the environment-friendly marine-farm-type mooring anchor module 300 according to the present embodiment may include an anchor module body 310 and a plurality of growth space sections 330. The anchor module body 310 may have a body-side pattern part formed in a remaining area thereof where the growth space sections 330 are not defined, the body-side pattern part including a plurality of body-side pattern members protruding or recessed with respect to the anchor module body 310. That is, since the body-side pattern part is formed in an area other than the portion where the growth space sections 330 are defined, it is possible to more smoothly settle aquatic organisms in the environment-friendly marine-farm-type mooring anchor module 300.

In this case, the pattern members 351 formed in each growth space section 330 may have different sizes or densities from the body-side pattern members.

FIG. 12 is a view illustrating a floating wind power system installation structure according yet another further embodiment of the present disclosure.

The floating wind power system installation structure according to the present embodiment has a different configuration from the overwater photovoltaic panel installation structure illustrated in FIGS. 1 to 11, except for the environment-friendly marine-farm-type mooring anchor module 300. Therefore, the main features of the present embodiment will be described below.

The floating wind power system installation structure, which is designated by reference numeral 6, according to the embodiment of the present disclosure includes a wind power system 620 including a pillar, a turbine unit located at the top of the pillar, and at least two blade units rotatably disposed on the turbine unit, a wind power system support assembly 610 disposed at the bottom of the pillar of the wind power system 620, and a connection unit having one side connected to the wind power system support assembly 610 and the other side fixed to the environment-friendly marine-farm-type mooring anchor module 300.

The environment-friendly marine-farm-type mooring anchor module 300 is connected to the wind power system support assembly 610, allows the wind power system support assembly 610 to be moored such that the turbine unit of the wind power system 620 supported by the wind power system support assembly 610 is exposed to the outside, and is seated on the floor surface of the ocean.

The floating wind power system installation structure 6 may be a pillar-type (cylindrical) structure, an offshore-platform-type (semi-submersible) structure, a tension-mooring-type (tension moored) structure, or the like.

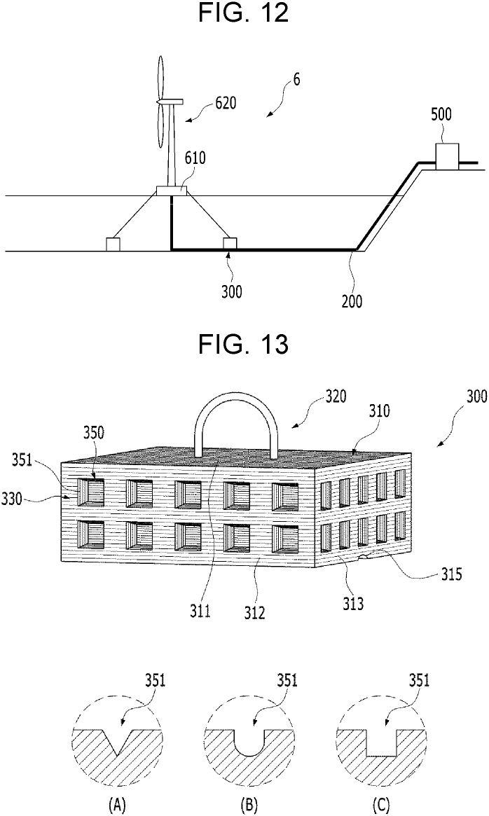

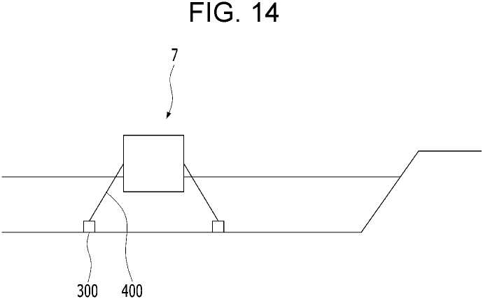

FIG. 13 is a view illustrating a configuration of an environment-friendly marine-farm-type mooring anchor module according to still yet another further embodiment of the present disclosure.

The environment-friendly marine-farm-type mooring anchor module, which is designated by reference numeral 300, according to the present embodiment has substantially the same configuration as that illustrated in FIG. 11, except for some configurations. Therefore, the main features of the present embodiment will be described below.

Referring to FIG. 13, the environment-friendly marine-farm-type mooring anchor module 300 according to the present embodiment includes a pattern part 350 including pattern members 351 in the form of a recessed linear pattern.

Each of the pattern members 351 may be, for example, at least one of a rectangular groove, a semicircular groove, and a V-shaped groove.

Although the present embodiment discloses that the pattern part 350 is arranged on the entire surface of the anchor module body 310, the present disclosure may have a configuration in which the pattern part 350 is formed only in each growth space section 330.

FIG. 14 is a view illustrating a floating breakwater installation structure according to a still further embodiment of the present disclosure.

Referring to FIG. 14, the floating breakwater installation structure according to the embodiment of the present disclosure includes a breakwater module 7 including a buoyancy body formed therein and a cover member surrounding the buoyancy body on the outside, at least 50% of the volume of the breakwater module 7 being exposed to the surface of water.

The breakwater module 7 is installed in a floating manner on the coast, and protects farms, floating photovoltaic facilities, etc., disposed on the coast by attenuating the waves generated toward the coast from the ocean.

The floating breakwater installation structure according to the embodiment of the present disclosure further includes a connection unit 400 having one side connected to the breakwater module 7 and the other side fixed to the environment-friendly marine-farm-type mooring anchor module 300. The environment-friendly marine-farm-type mooring anchor module 300 is connected to the breakwater module 7 through the connection unit 400 and is seated on the floor surface of the ocean, so as to moor the breakwater module 7 at a predetermined position.

Although preferred embodiments of the present disclosure have been described above, the present disclosure is not limited thereto. It will be apparent to those skilled in the art that various variations and modifications may be made within the scope of the detailed description and the accompanying drawings without departing from the spirit and scope of the disclosure as defined in the following claims.

1. An environment-friendly marine-farm-type mooring anchor module comprising a growth space where aquatic organisms are growable, comprising:
an anchor module body defining an external appearance thereof, a frame section disposed inside the anchor module body and made of a more rigid material than the anchor module body, and a connection section exposed through an upper surface of the anchor module body and having both lower ends coupled to the frame section, wherein:
the anchor module body has a plurality of growth space sections recessed from at least one surface thereof to provide a growth space for aquatic organisms;
each of the growth space sections comprises an inlet area disposed on an associated surface of the anchor module body, a bottom area facing the inlet area and forming a bottom surface of the growth space section, and a side area connecting the inlet area to the bottom area;
the inlet area is larger in size than the bottom area, and the side area is inclined; and
each of the growth space sections has a pattern part formed on a surface thereof, the pattern part comprising a plurality of pattern members protruding or recessed with respect to the surface of the growth space section.

2. An environment-friendly marine-farm-type mooring anchor module comprising a growth space where aquatic organisms are growable, comprising:
an anchor module body defining an external appearance thereof, a frame section disposed inside the anchor module body and made of a more rigid material than the anchor module body, and a connection section exposed through an upper surface of the anchor module body and having both lower ends coupled to the frame section, wherein:
the anchor module body has a plurality of growth space sections recessed from at least one surface thereof to provide a growth space for aquatic organisms;
the growth space sections are in communication with each other;
each of the growth space sections comprises an inlet area disposed on an associated surface of the anchor module body and a communication area connected to the inlet area;
the inlet areas of the growth space sections, which are defined respectively in parallel on one of the sides of the anchor module body and the other side facing the same, are in direct communication with each other through the associated communication areas of the growth space sections;
the inlet areas of the growth space sections, which are defined respectively on one of the sides of the anchor module body and the other side adjacent and perpendicular to the same, are in communication with each other through the associated communication areas of the growth space sections orthogonal to each other;
the frame section is disposed in a portion of the anchor module body in which the communication areas are not defined, so as not to be exposed through the communication areas;
each of the communication areas has a cross-sectional size smaller than or equal to an associated one of the inlet areas;
the cross-sectional size of the communication area is decreased as the distance from the inlet area is increased; and
each of the growth space sections has a pattern part formed on a surface thereof, the pattern part comprising a plurality of pattern members protruding or recessed with respect to the surface of the growth space section.

3. An environment-friendly marine-farm-type mooring anchor module comprising a growth space where aquatic organisms are growable, comprising:
an anchor module body defining an external appearance thereof, a frame section disposed inside the anchor module body and made of a more rigid material than the anchor module body, and a connection section exposed through an upper surface of the anchor module body and having both lower ends coupled to the frame section, wherein:
the anchor module body has a plurality of growth space sections recessed from at least one surface thereof to provide a growth space for aquatic organisms;
the growth space sections have different shapes and sizes;
one of the growth space sections and another growth space section adjacent thereto have different shapes or sizes;
the growth space sections have at least two of rectangular, pentagonal, triangular, and circular shapes; and
each of the growth space sections has a pattern part formed on a surface thereof, the pattern part comprising a plurality of pattern members protruding or recessed with respect to the surface of the growth space section.

4. The environment-friendly marine-farm-type mooring anchor module according to claim 1, wherein the anchor module body has a body-side pattern part formed in a remaining area thereof where the growth space sections are not defined, the body-side pattern part comprising a plurality of body-side pattern members protruding or recessed with respect to the anchor module body.

5. The environment-friendly marine-farm-type mooring anchor module according to claim 4, wherein:
each of the pattern members and the body-side pattern members has one or a combination of two or more of circular, rectangular, and linear shapes;
each of the pattern members and the body-side pattern members is in the form of at least one of a rectangular groove, a semicircular groove, and a V-shaped groove in cross-section; and
the pattern members formed in each of the growth space sections have different sizes or densities from the body-side pattern members.

6. The environment-friendly marine-farm-type mooring anchor module according to claim 1, wherein:
the anchor module body of the mooring anchor module is made of stone or concrete;
each of the growth space sections of the anchor module body has more pores than in other portions of the anchor module body in which the growth space sections are not defined; and
the anchor module body has at least one of a ceramic coating layer, an ocher coating layer, and a nanosilver coating layer formed on the surface thereof.

7. The environment-friendly marine-farm-type mooring anchor module according to claim 6, wherein the frame section is made of at least one or a combination of two or more of steel, fiber reinforced polymer (FRP) reinforcing material, glass fiber reinforced polymer (GFRP) reinforcing material, and carbon fiber reinforced polymer (CFRP) reinforcing material.

8. The environment-friendly marine-farm-type mooring anchor module according to claim 1, wherein the distance between the inlet area and the bottom area is 1/20 to ⅓ of the distance between one of the sides of the anchor module body and the other side facing the same.

9. An overwater photovoltaic panel installation structure, comprising the environment-friendly marine-farm-type mooring anchor module according to claim 1, further comprising:
buoyancy bodies spaced apart from each other;
a photovoltaic panel support assembly supported on the buoyancy bodies;
a plurality of photovoltaic panels supported by the photovoltaic panel support assembly; and
a connection unit having one side connected to the photovoltaic panel support assembly and the other side fixed to the environment-friendly marine-farm-type mooring anchor module,
wherein the environment-friendly marine-farm-type mooring anchor module is connected to the photovoltaic panel support assembly, is configured to moor the photovoltaic panel support assembly on the water, and is seated on the floor surface of the ocean.

10. The overwater photovoltaic panel installation structure according to claim 9, wherein:
the growth space sections does not overlap the frame section of the mooring anchor module;
the connection section comprises a connection area rounded and exposed upward from the anchor module body and having both ends embedded within the anchor module body, and bent areas disposed at and bent in a direction orthogonal to both ends of the connection area; and
the connection section is fixed to the anchor module body in a state in which the bent areas of the connection section are latched to at least one frame of the frame section and another frame in parallel therewith.

11. The environment-friendly marine-farm-type mooring anchor module according to claim 9, further comprising:
an air supply unit disposed on the photovoltaic panel support assembly and operated by power supplied from the photovoltaic panels, wherein:
each of the growth space sections has a plurality of air supply holes formed therein;
the anchor module body has at least air flow hole to which the air supply holes are connected;
the connection unit comprises a first conduit formed therein; and
one end of the first conduit is connected to the air supply unit and the other end of the first conduit communicates with the air flow hole, thereby allowing air to be supplied from the air supply unit to the air flow hole.

12. The overwater photovoltaic panel installation structure according to claim 11, further comprising:
a camera unit installed in the anchor module body to capture an underwater environment;
a sensing unit configured to measure an amount of oxygen in the water;
a communication unit configured to transmit information about the amount of oxygen in the water measured by the sensing unit to a management device; and
a control unit configured to control the air supply unit, the sensing unit, and the communication unit, wherein:
the connection unit comprises a second conduit disposed in parallel with and independent of the first conduit;
a probe unit connected to the sensing unit is inserted at one side thereof into and moved in the second conduit;
when the probe unit is moved toward the mooring anchor module in a state in which the probe unit is inserted into the second conduit, the sensing unit measures the amount of oxygen in the water near the floor surface of the ocean where the mooring anchor module is disposed, so as to transmit information about the measured amount of oxygen in the water to the management device;
the control unit controls the air supply unit to supply air to the mooring anchor module, based on the information about the amount of oxygen in the water, when the measured amount of oxygen in the water is smaller than a predetermined reference amount of oxygen; and
the reference amount of oxygen varies with the season.

13. The overwater photovoltaic panel installation structure according to claim 9, further comprising:
a power cable for transmitting electric power generated by the photovoltaic panels,
wherein at least a portion of the power cable is covered by the mooring anchor module.

14. A floating wind power system installation structure, comprising the environment-friendly marine-farm-type mooring anchor module according to claim 1, further comprising:
a wind power system comprising a pillar, a turbine unit located at the top of the pillar, and at least two blade units rotatably disposed on the turbine unit;
a wind power system support assembly disposed at the bottom of the pillar of the wind power system; and
a connection unit having one side connected to the wind power system support assembly and the other side fixed to the environment-friendly marine-farm-type mooring anchor module,
wherein the environment-friendly marine-farm-type mooring anchor module is connected to the wind power system support assembly, allows the wind power system support assembly to be moored such that the turbine unit of the wind power system supported by the wind power system support assembly is exposed to the outside, and is seated on the floor surface of the ocean.

15. A floating breakwater installation structure, comprising the environment-friendly marine-farm-type mooring anchor module according to claim 1, further comprising:
a breakwater module comprising a buoyancy body formed therein and a cover member surrounding the buoyancy body on the outside, at least 50% of the volume of the breakwater module being exposed to the surface of water; and
a connection unit having one side connected to the breakwater module and the other side fixed to the environment-friendly marine-farm-type mooring anchor module,
wherein the environment-friendly marine-farm-type mooring anchor module is connected to the breakwater module through the connection unit and is seated on the floor surface of the ocean.
